(19) United States
(12) Patent Application Publication
(10) Pub. No.: US 2010/0231709 A1
(43) Pub. Date: Sep. 16, 2010

(54) POSITION MEASUREMENT SYSTEM, POSITION MEASUREMENT METHOD AND COMPUTER-READABLE MEDIUM

(75) Inventors: Yasuji Seko, Kanagawa (JP); Hiroyuki Hotta, Kanagawa (JP); Yasuyuki Saguchi, Kanagawa (JP)

Correspondence Address: KIMBLE INTELLECTUAL PROPERTY LAW, PLLC, 1701 PENNSYLVANIA AVE., NW, SUITE 300, WASHINGTON, DC, 20006, US

(73) Assignee: Fuji Xerox Co., Ltd., Tokyo (JP)

(21) Appl. No.: 12/545,781

(22) Filed: Aug. 21, 2009

(30) Foreign Application Priority Data
Mar. 16, 2009 (JP) 2009-063666

(51) Int. Cl. H04N 7/18

(52) U.S. Cl. 348/135; 348/E07.085

(57) ABSTRACT

A position measurement system includes a marker set attached to an object, a camera and a computing apparatus. The marker set includes three or more directed basic markers each having a shape indicating a direction. The directed basic markers are oriented in directions toward a specific point. A positional relationship among the directed basic markers is known. The camera includes a two-dimensional imaging device configured to take an image of the marker set. The computing apparatus computes at least one of a position of the object and an angle of the object based on an image, taken by the camera, of the directed basic markers, which are oriented in the directions toward the specific point.

### CROSS-REFERENCE TO RELATED APPLICATIONS

This application is based on and claims priority under 35 USC 119 from Japanese Patent Application No. 2009-63666 filed on Mar. 16, 2009.

### BACKGROUND

### Technical Field

This invention relates to a position measurement system, a position measurement method and a computer-readable medium storing a program that causes a computer to execute a position measurement process.

### SUMMARY

According to an aspect of the invention, a position measurement system includes a marker set attached to an object, a camera and a computing apparatus. The marker set includes three or more directed basic markers each having a shape indicating a direction. The directed basic markers are oriented in directions toward a specific point. A positional relationship among the directed basic markers is known. The camera includes a two-dimensional imaging device configured to take an image of the marker set. The computing apparatus computes at least one of a position of the object and an angle of the object based on an image, taken by the camera, of the directed basic markers, which are oriented in the directions toward the specific point.

### BRIEF DESCRIPTION OF THE DRAWINGS

Exemplary embodiments of the invention will be described in detail below based on the accompanying drawings, wherein:

FIG. 1 is a drawing to show an example of a method for computing a three-dimensional position of a marker set having three or more basic markers;

FIGS. 2A and 2B are drawings to show examples of an object including a marker set having basic markers, FIG. 2A showing a single object, FIG. 2B showing three overlapping objects;

FIG. 3 is a drawing to show a position measurement system according to an exemplary embodiment of the invention;

FIGS. 4A and 4B are drawings to show examples of objects each including a marker set having basic markers in the exemplary embodiment of FIG. 3, FIG. 4A showing a single object, FIG. 4B showing three overlapping objects;

FIGS. 5A to 5F are drawings to show examples of shapes and arrangement of directed basic markers;

FIGS. 6A to 6F are drawings to show other examples of shapes and arrangement of the directed basic markers;

FIGS. 7A to 7D are drawings to show an example in which ID numbers are assigned to shapes of the directed basic markers;

FIG. 8 is a block diagram to show an example in which a personal computer (PC) is used as a computing apparatus; and

FIG. 9 is a flowchart to show an example of a procedure executed by the computer.

### DETAILED DESCRIPTION

Before a position measurement system according to an exemplary embodiment of the invention is described, an example of a measuring method in the position measurement system and a phenomenon in which objects to be measured overlap will be described.

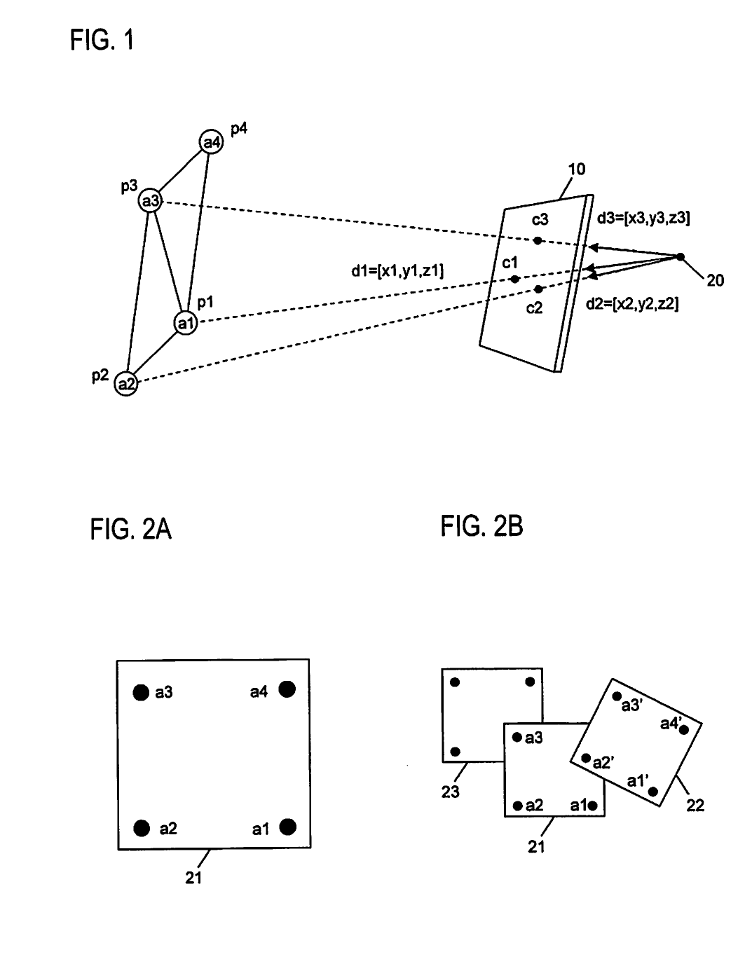

FIG. 1 is a drawing to show an example of a method for computing a three-dimensional position of a marker set having three or more basic markers. In the following description, it is assumed that the basic markers are light sources implemented by LEDs or the like. In this example, four light sources are placed at corners of a square, for example, and two combinations of three light sources among the four light sources will be described. Using the three points of the respective combinations, two solutions are derived using the following calculation. One of the two solutions is adopted as a correct solution because the light source positions indicate the same value. Accordingly, the position and the angle of the light source set can be determined.

At first, in FIG. 1, a direction vector di (i=1, 2, 3) of the light source position in a camera coordinate system is calculated based on a relationship between image positions c1, c2, and c3 of light sources (basic markers) a1, a2, and a3 on an image plane (a plane of a two-dimensional imaging device of the camera) 10 and an optical center 20 of the camera. It is assumed that di is a normalized unit vector. Also, it is assumed that di=(xi, yi, zi).

Letting position vectors of light sources a1, a2, and a3 in a space be p1, p2, and p3, they exist on an extension of the direction vector di and thus can be represented as

p1=t1·d1

p2=t2·d2

p3=t3·d3 Expression 1

where t1, t2, and t3 denote coefficients.

A shape of a triangle is known from the beginning, and it is assumed that lengths of sides of the triangle that

p1p2=L1

p2p3=L2

p3p1=L3 Expression 2

It is noted that in the expression 2, “pjpk” (j, k=1, 2, 3) means a length between a light source aj having a position vector pj and a light source ak having a position vector pk.
The following expression is obtained:

(t1·x1−t2·x2)²+(t1·y1−t2·y2)²+(t1·z1−t2·z2)²=L1²

(t2·x2−t3·x3)²+(t2·y2−t3·y3)²+(t2·z2−t3·z3)²=L2²

(t3·x3−t1·x1)²+(t3·y3−t1·y1)²+(t3·z3−t1·z1)²=L3² Expression 3

The following expression 4 is obtained by transforming the expression 3.

t1²−2t1t2(x1x2+y1y2+z1z2)+t2²−L1²=0

t2²−2t2t3(x2x3+y2y3+z2z3)+t3²−L2²=0

t3²−2t3t1(x3x1+y3y1+z3z1)+t1²−L3²=0 Expression 4

Then, the following expression 5 is obtained.

t1=A1·t2±\sqrt{(A1²−1)·t2²+L1²}

t2=A2·t3±\sqrt{(A2²−1)·t3²+L2²}

t3=A3·t1±\sqrt{(A3²−1)·t1²+L3²} Expression 5

where A1, A2, and A3 are as in the following expression:

A1=x1x2+y1y2+z1z2

A2=x2x3+y2y3+z2z3

A3=x3x1+y3y1+z3z1 Expression 6

If t1, t2 and t3 have real roots, values inside the respective square roots in expression 5 are positive.

$$t 1 \leq \sqrt{\frac{L {3}^{2}}{1 - A {3}^{2}}} \\ t 2 \leq \sqrt{\frac{L {1}^{2}}{1 - A {1}^{2}}} \\ t 3 \leq \sqrt{\frac{L {2}^{2}}{1 - A {2}^{2}}} \qquad Expression 7$$

The real numbers t1, t2, and t3 satisfying this condition are assigned to the expression 5 in order, and all t1, t2, and t3 where the expression 5 holds are calculated. Next, p1, p2, and p3, namely, the three-dimensional positions of the light sources are calculated based on the expression 1. When the number of light sources is three, two solutions are obtained. In the example, however, the number of light sources is four and thus, similar calculation to that described above is performed for another combination of three light sources, for example, a1, a3, and a4, and other two solutions are derived. One of the two solutions is adopted as a correct solution because the light source positions indicate the same value. The position and the angle of the light source set can be thus determined. When the number of light sources is three, for example, an average value of the two solutions or a value closer to the already known initial value can be adopted as a found value. The method of calculating the three-dimensional positions of the light sources (basic markers) is not limited to the method described above, and any other method may be adopted.

FIGS. 2A and 2B are drawings to show examples of objects each including a marker set having basic markers. FIG. 2A shows a single object, and FIG. 2B shows three overlapping objects. Each of the objects is shaped like a plate such as a card or a board, but not limited thereto (the same applies to the following description). In FIG. 2A, each of basic markers a1 to a4 of a marker set of an object 21 has a circular shape. Such a circular basic marker is not a shape indicating a direction. Therefore, if there are plural marker sets of this kind and if the basic markers of each marker set are taken using a camera, it is difficult to determine which marker set each basic marker belongs to. For example, as shown in FIG. 2B, each of the marker sets of objects 21, 22, and 23 may overlap the adjacent marker set. In this case, paying attention to the object 21, a basic marker a4 of the object 21 is covered with the object 22. Therefore, although the four correct basic markers of the object 21 are a1 to a4, it is concerned that they may be erroneously recognized as a1, a2, a3, and a2′ on an imaging screen of the camera, and calculation of position measurement may be performed according to this erroneous information. The exemplary embodiment of the invention is intended for excluding such confusion among the basic markers.

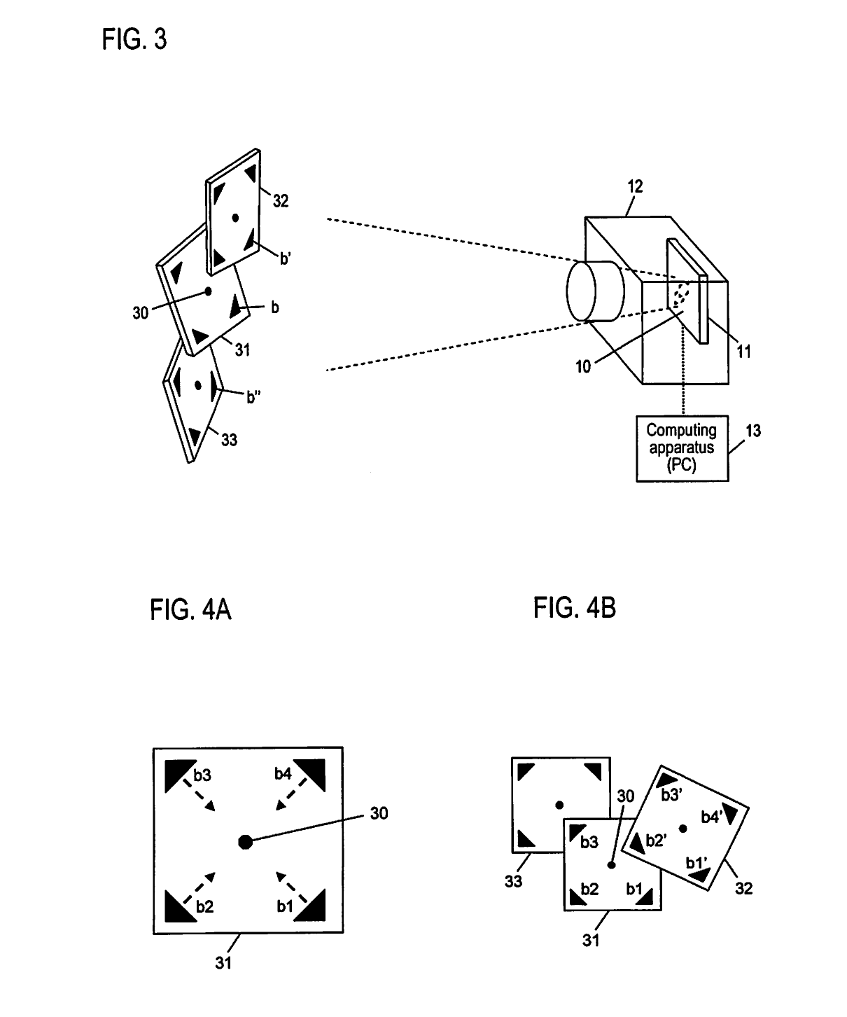

FIG. 3 is a drawing to show a position measurement system according to an exemplary embodiment of the invention. As shown in the figure, the position measurement system of this exemplary embodiment includes marker sets attached to respective objects 31 to 33, a camera 12 and a computing apparatus 13. Each marker set includes three or more directed basic markers b (b′, b″). Each directed basic marker has a shape indicating a direction. The directed basic markers are oriented in directions toward a specific point 30. A positional relationship among the directed basic markers is known. The camera 12 includes a two-dimensional imaging device 11 configured to take an image of the marker set(s). The computing apparatus 13 computes at least one of a position and an angle of each of the objects 31 to 33 based on an image, taken by the camera 12, of the directed basic markers b (b′, b″) which are oriented in the directions toward the specific point 30. A configuration example of the computing apparatus 13 will be described later. In this exemplary embodiment, the specific point 30 exists inside a polygon which has the directed basic markers b (b′, b″) as its vertexes. However, it should be noted that the specific point 30 is not limited to the mode. For example, the specific point may overlap the position of any of the directed basic markers (as described later). The marker set may further have a non-directed basic marker indicating no direction, and the specific point 30 may be in a position of the non-directed basic marker.

A plate shape member such as a card or a board may be used as each of the objects 31 to 33. It is noted that the objects 31 to 33 are not limited thereto. The directed basic markers b (b′, b″) are not limited to particular ones so long as they can be taken with a camera to obtain image information. For example, the directed basic marker may be printed or put on an object. A light source such as an LED may be used as the directed basic marker. Also, a retroreflective plate may be used in place of a light source, and a lighting device for lighting the retroreflective plate may be provided. Examples of the camera 12 include, for example, a digital camera having a two-dimensional imaging device such as a CCD sensor or a CMOS sensor. It should be noted that the camera 12 is not limited thereto. The computing apparatus 13 is connected to a communication device (not shown) of the camera 12 in a wired or wireless manner so that it can communicate with the camera 12. Examples of the computing apparatus 13 include, for example, a computer such as a personal computer (PC). It is noted that the computing apparatus 13 is not limited thereto.

FIGS. 4A and 4B are drawings to show examples of the objects each including a marker set having basic markers in the exemplary embodiment of FIG. 3. FIG. 4A shows a single object, and FIG. 4B shows three overlapping objects. As shown in FIG. 4A, the object 31 of this exemplary embodiment has directed basic markers b1 to b4 each having a shape indicating a direction and each being oriented for the direction toward the specific point 30 on a quadrilateral board. In this exemplary embodiment, the directed basic markers b1 to b4 each has each a shape of an isosceles right triangle. The directed basic markers b1 to b4 are placed so that the isosceles right triangles correspond to the corners of the quadrilateral. The specific point 30 is a point where perpendiculars, each of which passes through a center point of a base of a corresponding one of the isosceles right triangle, intersect each other. The specific point 30 may be a virtual point having no real body. Alternatively, any desired basic marker may be placed in a position of the specific point for use in position measurement. The shapes and arrangement of the directed basic markers are not limited to those mentioned above, and various forms may be adopted as described later.

As shown in FIG. 4B, the case where each of the objects 31 to 33 overlaps the adjacent object will be described. In this case, paying attention to the object 31, the directed basic marker b4 of the object 31 is covered with the object 32. Therefore, although the four correct directed basic markers of the object 31 are b1 to b4, it is concerned that the directed basic markers of the object 31 may be erroneously recognized as b1, b2, b3, and b2′ on an imaging screen of the camera. In this exemplary embodiment, however, the directed basic marker b2′ is not oriented in the direction toward the specific point 30 of the object 31. Thus, it is determined that the directed basic marker b2′ does not belong to the object 31, and the directed basic marker b2′ is not used in calculation of position measurement of the object 31. This determination is made by the computing apparatus 13 shown in FIG. 3, for example, but may be made elsewhere. Thus, calculation of position measurement is executed based on an image of plural directed basic markers b1, b2 and b3 oriented in the direction toward the specific point 30, so that position measurement can be performed without the directed basic markers of the object 31 being confused with a directed basic marker(s) of another marker set (32, 33).

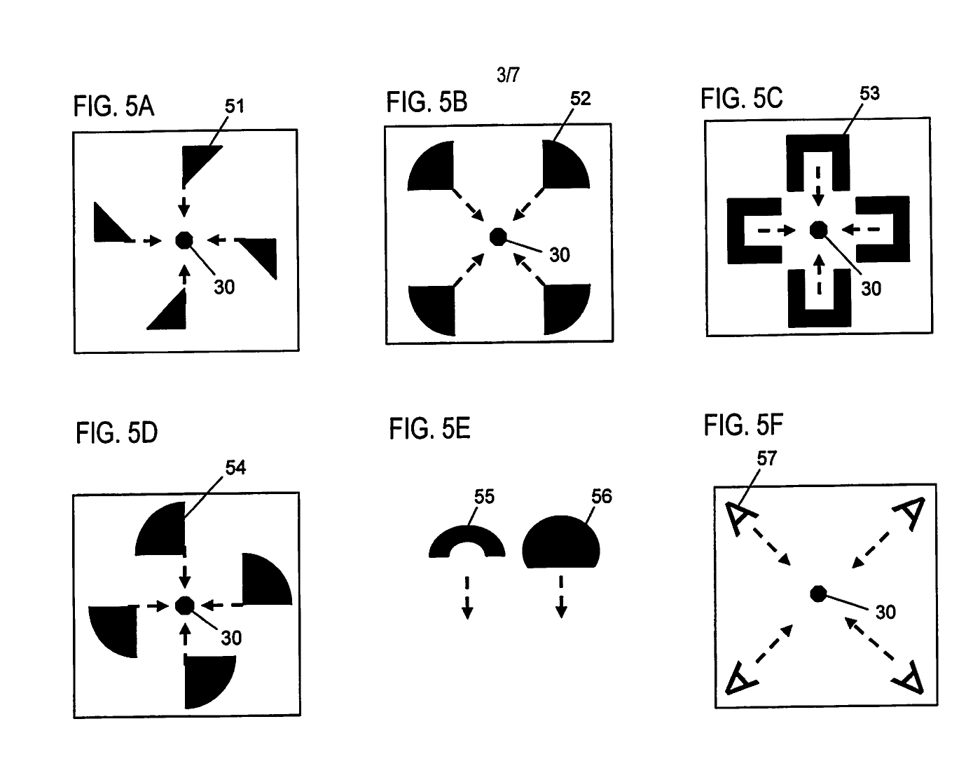

FIGS. 5A to 5F are drawings to show examples of the shapes and arrangement of the directed basic markers. In FIG. 5A, the shape of each directed basic marker is an isosceles right triangle as in the example of FIG. 4, but each isosceles right triangle 51 is arranged so that an extension of one of equal sides becomes a perpendicular passing through a center point of a corresponding one of sides of a quadrilateral. The specific point 30 is a point where the perpendiculars intersect each other. In FIG. 5B, the shape of each directed basic marker is a sector 52. Each sector 52 is arranged so that a circular arc part is oriented to the vertex side of a quadrilateral, and two sides are parallel to the sides of the quadrilateral.

The specific point 30 is a point where perpendiculars, each of which passes through a center point of the circular arc part of each sector 52 intersect each other. In FIG. 5C, the shape of each directed basic marker is a U shape 53. Each U shape 53 is arranged so that a straight line part opposed to an opening part is parallel to a center of a corresponding one of sides of a quadrilateral. The specific point 30 is a point where perpendiculars, each of which passes through a center point of the straight line part opposed to the opening part of a corresponding one of the U shapes 53, intersect each other.

In FIG. 5D, the shape of each directed basic marker is a sector as in the example of FIG. 5B, but each sector 54 is arranged so that an extension of one of two sides thereof is a perpendicular passing through a center line of a corresponding one of sides of a quadrilateral. The specific point 30 is a point where the perpendiculars intersect each other. The shapes of the directed basic markers are not limited to the examples described above. For example, as shown in FIG. 5E, the directed basic markers may have a shape of one designated by 55 which is a part of a donut shape, a shape of one designated by 56 which is a remaining part obtained by linearly deleting a part of a circle and the like. That is, the directed basic marker may have a geometric shape formed of at least one of a straight line and a curve. As shown in FIG. 5F, the directed basic marker may also have a shape of a character such as “A” as designated by a reference numeral 57. The character shape may be not only an alphabetic latter of A, B, C, etc., but also a kanji character or a character of any other language.

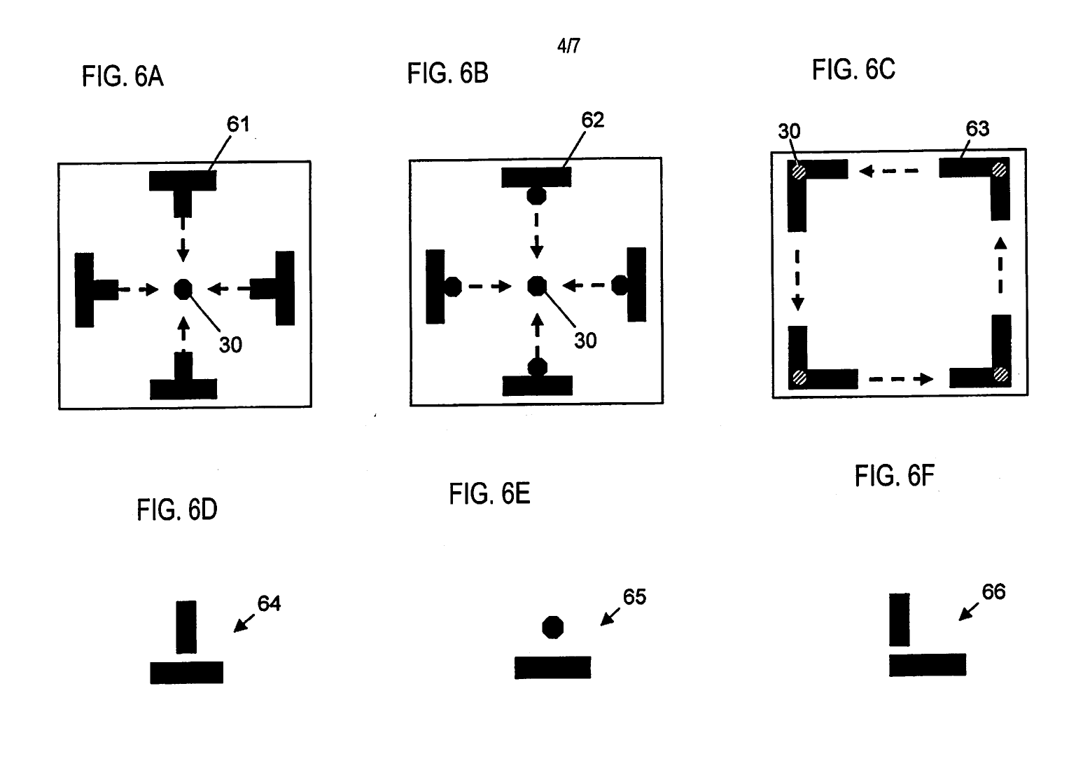

FIGS. 6A to 6F are drawings to show other examples of the shapes and arrangement of the directed basic markers. In FIG. 6A, the shape of each directed basic marker is a T shape 61. Each T shape 61 is arranged so that an extension of a vertical line of the T shape becomes a perpendicular passing through a center point of a corresponding one of sides of a quadrilateral. The specific point 30 is a point where the perpendiculars intersect each other. In FIG. 6B, the shape of each directed basic marker is a pot lid shape 62. Each pot lid shape 62 is arranged so that a lid part for a holding part is arranged to be parallel to a corresponding one of sides of a quadrilateral and a perpendicular passing through a center point of each lid part passes through a center point of the corresponding one of the sides of the quadrilateral. The specific point 30 is a point where the perpendiculars intersect each other. In FIG. 6C, the shape of each directed basic marker is an L shape 63. Each L shape 63 is arranged so that its corner corresponds to each vertex of a quadrilateral. In this example, the specific points 30 are the corner parts of the respective L shapes 63. That is, the specific point 30 for each L shape 63 is a position of an L shape 63 at a next stage to which a line part located on the counterclockwise side of each L shape 63 is oriented. In this case, the specific points 30 overlap the position of the directed basic markers 63, and thus the plural specific points 30 are provided so that the number of specific points 30 is equal to the number of directed basic markers 63.

FIG. 6D shows a modified example of the shape of the directed basic marker shown in FIG. 6A. Two rectangle parts constituting the T shape 61 are separated to form a shape 64. FIG. 6E shows a modified example of the shape of the directed basic marker shown in FIG. 6B. The rectangle and the circle constituting the pot lid shape 62 are separated to form a shape 65. FIG. 6F shows a modified example of the shape of the directed basic marker shown in FIG. 6C. Two rectangle parts constituting the L shape 63 are separated to form a shape 66.

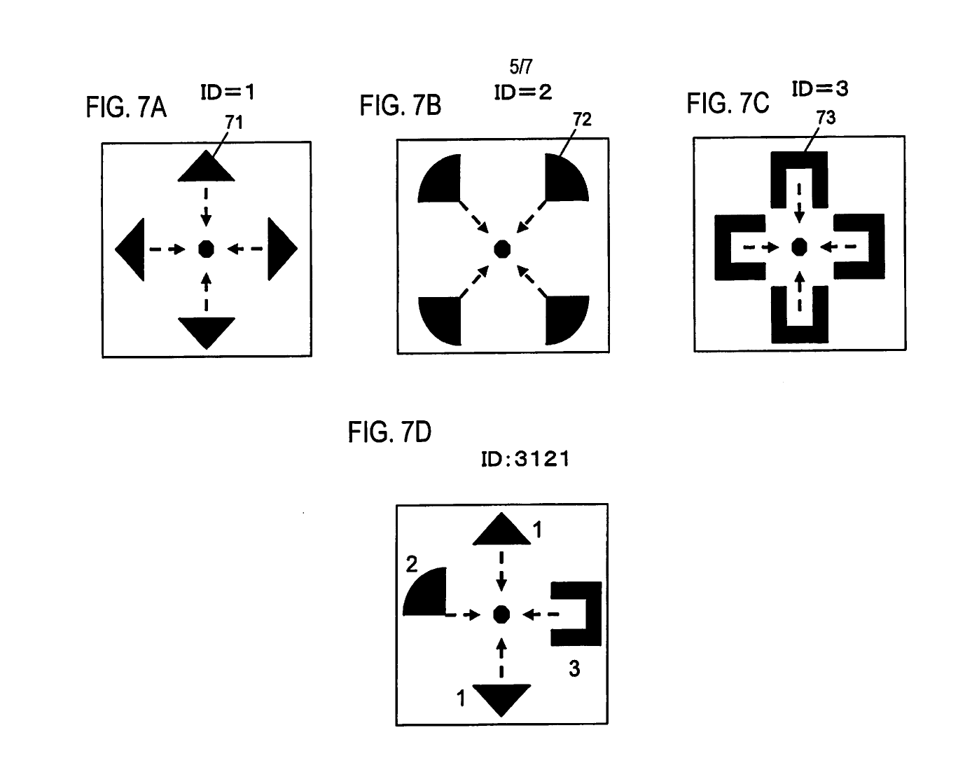

FIGS. 7A to 7D are drawings to show an example in which ID numbers are assigned to the shapes of the directed basic markers. In the example, ID number “1” is assigned to an isosceles right triangle 71 shown in FIG. 7A, ID number “2” is assigned to a sector 72 shown in FIG. 7B, and ID number “3” is assigned to a U shape 73 shown in FIG. 7C. FIG. 7D shows a marker set containing directed basic markers having different shapes shown in FIGS. 7A to 7C. In this case, ID number “3121” is assigned to the marker set of FIG. 7D. In this position measurement system, the shapes of the directed basic markers and the ID numbers shown in FIGS. 7A to 7C are put into a table in association with each other, and the table is stored in a storage (not shown). The computing apparatus 13 determines an ID number of each taken directed basic marker based on the correspondence relation between the shape of each directed basic marker in the taken image of the camera 12 and the ID number in the table stored in the storage. When the ID number is to be assigned to each marker set, the ID number may be given in such a manner that starting at the largest “3” as the ID number of the directed basic marker, the numbers “1,” “2,” and “1” corresponding to the directed basic markers are assigned clockwise in order as in this example. However, the method of assigning the ID number is not limited thereto. The ID number can be thus assigned to the marker set having directed basic markers having different shapes.

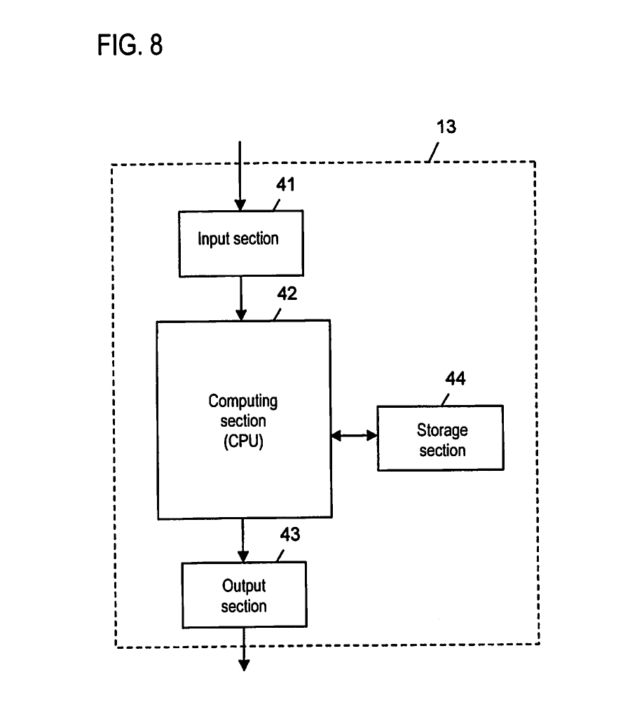

FIG. 8 is a block diagram to show an example in which a personal computer (PC) is used as the computing apparatus. The computing apparatus 13 includes an input section 41, a computing section (CPU 42), an output section 43 and a storage section 44. The input section 41 inputs image information of a marker set having three or more directed basic markers taken by the two-dimensional imaging device 11 of the camera 12. The computing section 42 computes at least one of a three-dimensional position and an angle of an object (to which the marker set is attached) based on the input image information. The output section 43 outputs at least one of the computed three-dimensional positions and the computed angle of the object, for example, to a display such as a monitor. The storage section 44 is connected to the computing section 42, and information is transferred therebetween. The storage section 44 stores a program executed by the computing section 42 and various pieces of information that are used in the program. The storage section 44 may implement an internal memory. It is noted that the storage section 44 is not limited thereto, but may be an external storage.

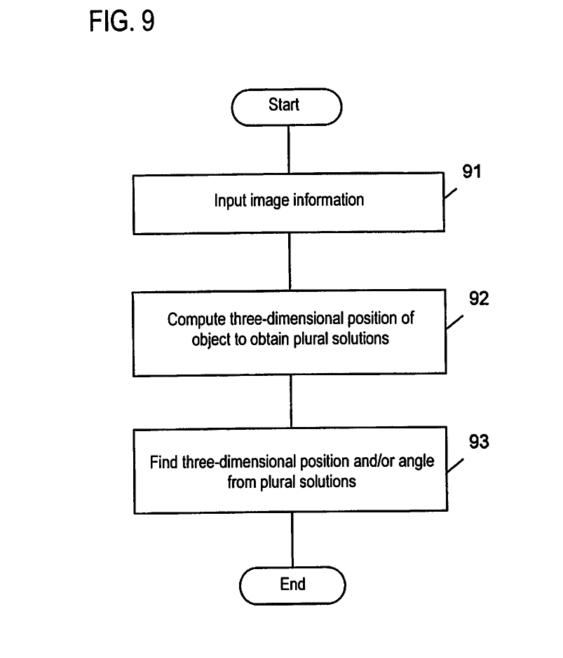

The procedure described above may be executed by having a computer to execute the following program. FIG. 9 is a flowchart to show an example of the procedure executed by the computer. That is, the program is a program for causing a computer to execute the steps of inputting image information of directed basic markers which are oriented in a direction toward a specific point, obtained by using a camera to take a marker set having the three or more directed basic markers each having a shape indicating a direction with a known positional relationship among the directed basic markers being known, the marker set being attached to an object (step 91), calculating a three-dimensional position of the object based on the input image information to find plural solutions (step 92), and finding at least one of the three-dimensional position and an angle of the object based on the plural solutions (step 93). In the description of the exemplary embodiment, the program is stored in the storage section of the computing apparatus. However, the program may also be provided in a state where the program is stored in a storage medium such as a CD-ROM. Also, the program may be distributed through a communication device.

The foregoing description of the exemplary embodiments of the invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A position measurement system comprising:
a marker set attached to an object, wherein
the marker set includes three or more directed basic markers each having a shape indicating a direction,
the directed basic markers are oriented in directions toward a specific point, and
a positional relationship among the directed basic markers is known;
a camera including a two-dimensional imaging device configured to take an image of the marker set; and
a computing apparatus that computes at least one of a position of the object and an angle of the object based on an image, taken by the camera, of the directed basic markers, which are oriented in the directions toward the specific point.

2. The position measurement system according to claim 1, wherein the specific point exists inside a polygon which has the directed basic markers as vertexes.

3. The position measurement system according to claim 1, wherein
the marker set further includes a non-directed basic marker indicating no direction, and
the specific point is located in a position of the non-directed basic marker.

4. The position measurement system according to claim 1, wherein each directed basic markers has a shape formed of at least one of a straight line and a curve.

5. The position measurement system according to claim 1, wherein each directed basic marker has a shape of a character.

6. The position measurement system according to claim 1, wherein the marker set includes the directed basic markers having different shapes.

7. The position measurement system according to claim 6, wherein the marker set has an ID number which is given based on the directed basic markers having the different shapes.

8. A position measurement system comprising:
a marker set attached to an object, wherein
the marker set includes three or more directed basic markers each having a shape indicating a direction,
the directed basic markers are oriented in directions toward specific points, respectively,
each specific point overlaps a position of a corresponding one of the directed basic markers, and
a positional relationship among the directed basic markers is known;
a camera including a two-dimensional imaging device configured to take an image of the marker set; and
a computing apparatus that computes at least one of a position of the object and an angle of the object based on an image, taken by the camera, of the directed basic markers, which are oriented in the directions toward the specific point.

9. A position measurement method, wherein
a marker set is attached to an object,
the marker set includes three or more directed basic markers each having a shape indicating a direction,
the directed basic markers are oriented in directions toward a specific point, and
a positional relationship among the directed basic markers is known,
the method comprising:
taking an image of the marker set using a camera including a two-dimensional imaging device; and
computing at least one of a position of the object and an angle of the object based on an image, taken by the camera, of the directed basic markers, which are oriented in the directions toward the specific point.

10. The position measurement method according to claim 9, wherein the specific point exists inside a polygon which has the directed basic markers as vertexes.

11. The position measurement method according to claim 9, wherein
the marker set further includes a non-directed basic marker indicating no direction, and
the specific point is located in a position of the non-directed basic marker.

12. The position measurement method according to claim 9, wherein each directed basic markers has a shape formed of at least one of a straight line and a curve.

13. The position measurement method according to claim 9, wherein each directed basic marker has a shape of a character.

14. The position measurement method according to claim 9, wherein the marker set includes the directed basic markers having different shapes.

15. The position measurement method according to claim 14, wherein the marker set has an ID number which is given based on the directed basic markers having the different shapes.

16. A position measurement method, wherein
a marker is set attached to an object,
the marker set includes three or more directed basic markers each having a shape indicating a direction,
the directed basic markers are oriented in directions toward specific points, respectively,
each specific point overlaps a position of a corresponding one of the directed basic markers, and
a positional relationship among the directed basic markers is known;
the method comprising:
taking an image of the marker set using a camera including a two-dimensional imaging device; and
computing at least one of a position of the object and an angle of the object based on an image, taken by the camera, of the directed basic markers, which are oriented in the directions toward the specific point.

17. A computer-readable medium storing a program that causes a computer to execute a position measurement process, wherein
a marker set is attached to an object,
the marker set includes three or more directed basic markers each having a shape indicating a direction,
the directed basic markers are oriented in directions toward a specific point, and
a positional relationship among the directed basic markers is known,
the position measurement process comprising:
taking an image of the marker set using a camera including a two-dimensional imaging device; and
computing at least one of a position of the object and an angle of the object based on an image, taken by the camera, of the directed basic markers, which are oriented in the directions toward the specific point.
